(19) United States
(12) Patent Application Publication
(10) Pub. No.: US 2006/0049345 A1
(43) Pub. Date: Mar. 9, 2006

(54) Radiation monitoring apparatus, systems, and methods

(75) Inventors: M. Vikram Rao, Houston, TX (US); Paul F. Rodney, Spring, TX (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Halliburton Energy Services, Inc.

(21) Appl. No.: 10/937,176

(22) Filed: Sep. 9, 2004

(51) Int. Cl. G01V 5/08

(52) U.S. Cl. 250/269.1

(57) ABSTRACT

In some embodiments, radiation may be detected by emitting photons responsive to the radiation at a first location, and transporting the photons to provide an indication of photon presence at the second location. In some embodiments, operations may include generating a current at a first location by receiving radiation from a source at a semiconductor junction, and transporting the current to provide an indication of source presence at the second location.

### TECHNICAL FIELD

Various embodiments described herein relate to monitoring radiation generally, including apparatus, systems, and methods that can be used to detect and indicate the presence of radiation.

### BACKGROUND INFORMATION

Radiation detection mechanisms, perhaps used to determine the unauthorized use of certain materials, may include rather fragile devices, such as Geiger-Muller tubes. These devices may not readily survive rough handling, and may utilize relatively complex electrical circuitry to process the signals obtained therefrom (e.g., accumulating counters).

### BRIEF DESCRIPTION OF THE DRAWINGS

FIG. 1 is a block diagram of apparatus and systems according to various embodiments of the invention;

FIG. 2 is a block diagram of additional example embodiments of the invention; and

FIGS. 3A and 3B are flow diagrams illustrating several methods according to various embodiments of the invention.

### DETAILED DESCRIPTION

In some embodiments of the invention, the challenges described above may be addressed by taking advantage of photon emission that can occur in response to radiation, perhaps using an unpowered detector. For example, a radiation container, such as a radiation source transport pig, may contain a source of radiation and a detector (e.g., a scintillating crystal). The crystal may emit photons in the visible light region responsive to radiation, and an optical fiber can be used to transport the photons from the interior of the container to the exterior, where the photons can be viewed, or received for further processing. In some embodiments, the optical fiber may include a doped portion that responds to radiation by emitting photons that can be transported along the remainder of the fiber.

It should be noted that adopting the approach disclosed herein may present several advantages. For example, warning lights included on the dashboard of an automobile, while depicting a change between normal and dangerous pressure levels, typically rely upon a quantitative measurement of pressure, despite the fact that the user only sees an apparent change in state. Smoke detectors, monitors at nuclear reactors and refineries, as well as other detection systems usually depend on quantitative measurement to cross a threshold and set off an alarm. In many of the disclosed embodiments, particle flux is not quantitatively measure.

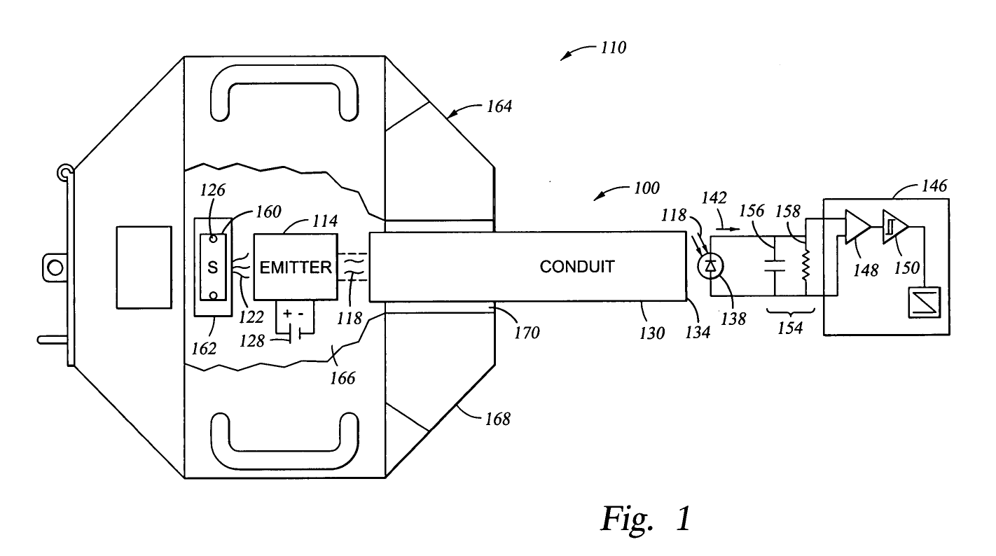

FIG. 1 is a block diagram of apparatus 100 and systems 110 according to various embodiments of the invention which may operate in the manner previously described. For example, an apparatus 100 may comprise a photon emitter 114 to emit photons 118 responsive to radiation 122 provided by a source 126.

The photon emitter 114 may comprise a number of devices, such as one or more of a scintillator, a scintillating crystal, sodium-iodine, and a piece of scintillation plastic. Thus, the photon emitter 114 may be unpowered. In some embodiments, however, the photon emitter may be powered. For example, a powered photon emitter 114 might comprise a semiconductor junction (e.g., a complementary metal-oxide semiconductor (CMOS) diode junction, a bipolar junction, or a PIN diode junction) that generates a current responsive to radiation, coupled to a light-emitting transistor, similar to or identical to those devices described in “Light-Emitting Transistor: Light Emission From InGaP/GaAs Heterojunction Bipolar Transistors”, M. Feng et al., Applied Physics Letters, Volume 84, Issue 1, pp. 151-153, incorporated herein by reference in its entirety. For more information regarding radiation detection with PIN diodes, one may consult “Silicon PIN Diode Radiation Detectors”, Carroll-Ramsey Associates, Berkeley, Calif., 1999, also incorporated herein by reference in its entirety. In this case, then, the semiconductor junction might provide a current responsive to radiation received at the junction, which may in turn cause light to be emitted from a light-emitting transistor coupled to receive the current from the semiconductor junction. The photon emitter 114 may also receive power from a separate power source, such as a battery 128. In many embodiments, then, the photon emitter 114 provides a non-quantitative response to radiation.

Sources 126 of radiation received by the photon emitter 114 may be selected from a number of possibilities, including one or more of natural (e.g., chemical) gamma ray emitters, natural x-ray emitters, natural neutron emitters, natural alpha particle emitters, natural electron emitters, natural position emitters, and natural proton emitters. Sources 126 that provide \check{C}erenkov radiation, pulsed neutron tubes, and conventional x-ray tubes may also be used. In some embodiments, the source may be capable of providing radiation at a rate of greater than about 2·10⁸ particles per second through a surface surrounding the source, such as a substantially spherical surface.

The apparatus 100 may also include an optical conduit 130 (e.g., one or more optical fibers) to transport the photons 118. In some embodiments, the photon emitter 114 may comprise a doped portion of the optical conduit 130. Thus, the photon emitter 114 may be physically separate from the optical conduit 130, or made so as to form an integral part of the optical conduit 130.

At the distal end 134 of the optical conduit 130, the photons 118 may be perceived directly by human observers. However, in some embodiments, the apparatus 100 may be constructed so as to aid such perception by including a receptor 138 to receive the photons 118 from the optical conduit 130 and to provide an electrical indication 142 of photon presence. The receptor 138 may comprise a photo-diode and a photomultiplier, among others.

In some embodiments, the apparatus 100 may include a threshold indicator 146 to receive the electrical indication 142 of the photon presence and to indicate the photon presence when a number of photons 118 received per unit time is greater than a selected level. The threshold indicator may include a number of components, such as an amplifier 148, to amplify the electrical indication 142, and/or a Schmitt trigger 150 to provide a binary output, such as a logic high or ON state that means a source 126 is present, and a logic low or OFF state that means the source is absent.

The apparatus 100 may include filtering components 154, such as a capacitor 156 coupled to the receptor 138, and a resistor 158 coupled to the capacitor 156. The capacitor 156 and resistor 158 may be selected to provide an associated time constant, such that the time constant (e.g., the product of capacitance in farads and resistance in ohms) associated with the capacitor 156 and the resistor 158 is less than a desired indication response time, such as about 0.1 seconds and/or greater than about the reciprocal of the Poisson rate parameter of the process being monitored (e.g., a selected number of radiation particles received per second) at the photon emitter 114. Other embodiments may be realized.

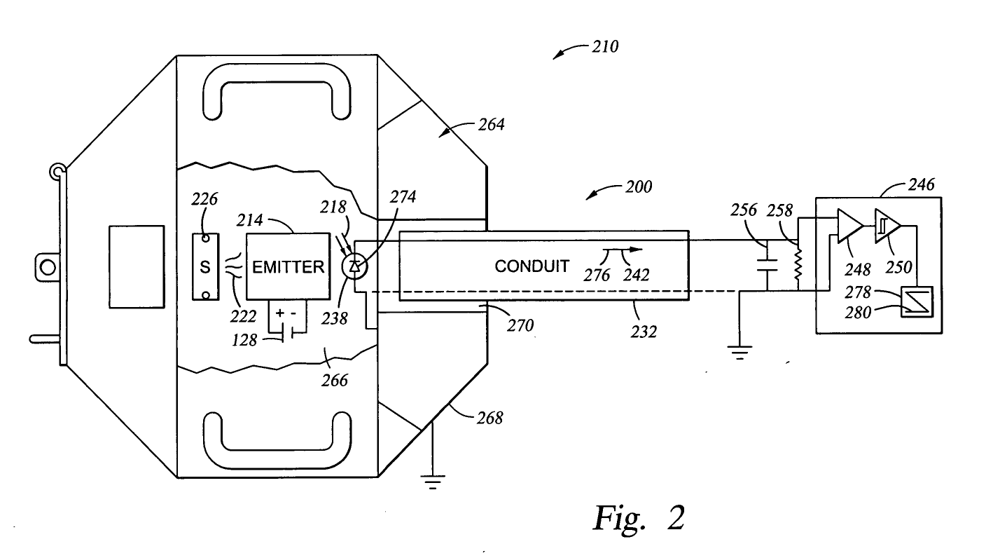

For example, FIG. 2 is a block diagram of additional example embodiments of the invention. As shown, an apparatus 200 may include a photon emitter 214 to emit photons 218 responsive to radiation 222, as well as a receptor 238 optically coupled to the photon emitter 214 to provide an electrical indication 242 (e.g., a current) of photon presence responsive to receiving the photons 218. The photon emitter 214 and receptor 238 may be similar to, or identical to the photon emitter 114 and receptor 138 shown in FIG. 1, respectively.

The apparatus 200 may also include an electrical conduit 232 to transport the electrical indication 242 of photon presence. The electrical conduit 232 may comprise one or more conductors. Thus, the electrical conduit 232 may comprise a single electrical conductor, with return currents carried in ground connections (shown in FIG. 2). In some embodiments, the electrical conduit 232 may comprise an antenna to transport the electrical indication 242 as a carrier wave.

In some embodiments, the apparatus 200 may include a threshold indicator 246 similar to, or identical to the threshold indicator 146 of FIG. 1. Thus, the threshold indicator 246 may be used to receive the electrical indication 242 of photon presence from the electrical conduit 232 and to indicate the photon presence when the number of photons received per unit time is greater than a selected level. The threshold indicator 246 may include an amplifier 248, and/or a Schmitt trigger 250, as well as a capacitor 256 coupled to the electrical conduit 232 and a resistor 258. The time constant associated with the capacitor 256 and the resistor 258 may be selected in the same manner as described with respect to the capacitor 156 and resistor 158 described above. Other embodiments may be realized.

For example, referring now to FIG. 1, it can be seen that a system 110 may comprise one or more apparatus, similar to or identical to the apparatus 100, as well as a laser 160 to provide the radiation 122. For example, the laser 160 may be included in a tool 162 comprising a cutting tool, and/or a fusing tool. Such tools may be similar to, or identical to the Waterlase® YSGG dental laser and LaserSmile™ soft tissue laser tools available from Biolase Technology, Inc. of San Clemente, Calif. Thus, the tool 162 may comprise a tool to operate on human-tissue, which may be configured to provide the radiation in conjunction with a laser-energized water spray. The tool 162 may also comprise higher-powered laser systems, such as a metal cutting tool, including those similar to or identical to the Epilog Mini engraving and cutting system and the Legend 32EX cutting system, both available from Epilog Laser of Golden, Colo. Still other embodiments may be realized.

For example, in some embodiments, a system 110 may comprise one or more apparatus, similar to or identical to the apparatus 100, as well as a radiation container 164 (e.g., a radiation source transport pig, a well logging radioactive source pig, a drum, or any other container that can be used to transport any kind of radiation source, including radioactive waste) having an interior portion 166 and an exterior portion 168. The interior portion 166 may be used to contain the photon emitter 114. The optical conduit 130 may be carried by a passage 170 extending from the interior portion 166 to the exterior portion 168 of the radiation container 164. In some embodiments, the passage 170 may comprise a tortuous passage.

Referring now to FIG. 2, it can be seen that in some embodiments, a system 210 may comprise one or more apparatus, similar to or identical to the apparatus 200, as well as a radiation container 264, which may in turn be similar to or identical to the radiation container 164 of FIG. 1. The radiation container 264 may therefore have an interior portion 266 containing the photon emitter 214 and the receptor 238. The system 210 may include an electrical conduit 232 to transport the electrical indication 242 of photon presence from the interior portion 266 to an exterior portion 268 of the radiation container 264, perhaps in a passage 270, such as a tortuous passage. Many other embodiments may be realized.

For example, an apparatus 200 may comprise a semiconductor junction 274 that is directly responsive to radiation 222, such that the semiconductor junction 274 may be used to generate a current 276 responsive to radiation provided by the source 226. The apparatus 200 may also include a receptor 278 to provide an indication of source presence 280 responsive to the current 276. The receptor 278 may be coupled to the semiconductor junction 274 directly, or indirectly (as shown in FIG. 2), perhaps via an electrical conduit 232. The semiconductor junction 274 may comprise a number of technologies, including a bipolar junction, a complementary metal-oxide semiconductor (CMOS) junction, and a PIN diode junction, among others. As noted previously, the apparatus 200 may include, a threshold indicator 246, which may in turn include an amplifier, a Schmitt trigger, and/or a capacitor and resistor coupled to each other and to an electrical conduit 232 used to transport the current 276.

The apparatus 100, 200; photon emitters 114, 214; photons 118, 218; radiation 122, 222; sources 126, 226; battery 128; optical conduit 130, distal end 134; receptors 138, 238, 278; electrical indications 142, 242; threshold indicators 146, 246; amplifiers 148, 248; Schmitt triggers 150, 250; filtering components 154; capacitors 156, 256; resistors 158, 258; laser 160; tool 162; radiation containers 164, 264; interior portions 166, 266; exterior portions 168, 268; passages 170, 270; electrical conduit 232; semiconductor junction 274; current 276 and indication of source presence 280 may all be characterized as “modules” herein. Such modules may include hardware circuitry, and/or a processor and/or memory circuits, software program modules and objects, and/or firmware, and combinations thereof, as desired by the architect of the apparatus 100, 200 and systems 110, 210, and as appropriate for particular implementations of various embodiments. For example, in some embodiments, such modules may be included in an apparatus and/or system operation simulation package, such as a software electrical signal simulation package, a power usage and distribution simulation package, a capacitance-inductance simulation package, a radiation detection simulation package, and/or a combination of software and hardware used to simulate the operation of various potential embodiments.

It should also be understood that the apparatus and systems of various embodiments can be used in applications other than for laser tools and radiation containers, and thus, various embodiments are not to be so limited. The illustrations of apparatus 100, 200 and systems 110, 210 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, processor modules, embedded processors, data switches, and application-specific modules, including multilayer, multi-chip modules. Such apparatus and systems may further be included as sub-components within a variety of electronic systems, such as display systems, cellular telephones, personal computers, workstations, radios, video players, vehicles, and others. Further embodiments include a number of methods.

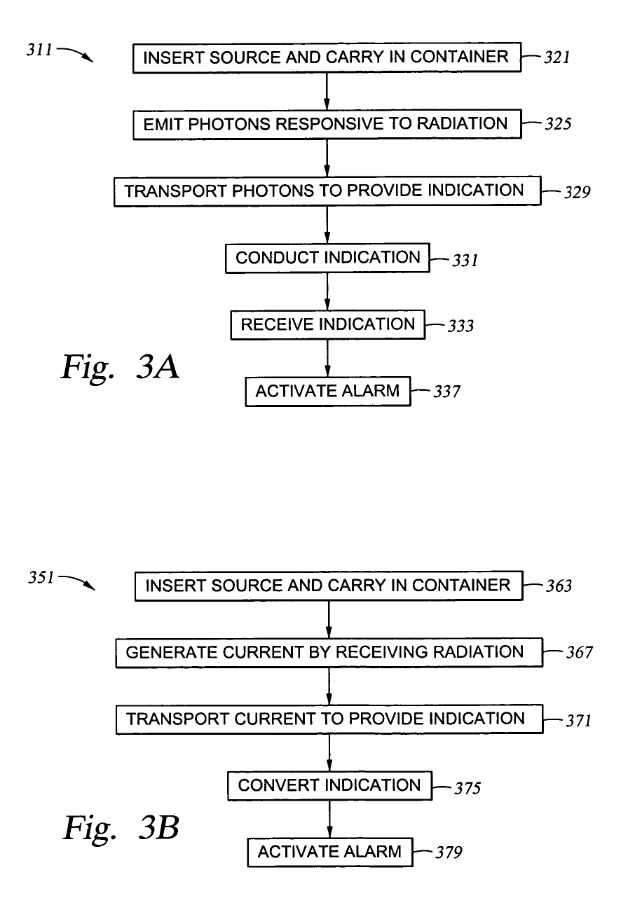

For example, FIGS. 3A and 3B are flow diagrams illustrating several methods according to various embodiments of the invention. Turning now to FIG. 3A, it can be seen that a method 311 may (optionally) begin at block 321 with inserting a source of radiation into the interior portion of a radiation container. The method 311 may also include carrying the source of radiation in the interior portion of the radiation container at block 321.

The method 311 may include emitting photons responsive to radiation at a first location (e.g., proximate to a laser included in a cutting/fusing tool, or within the interior portion of a radiation container) at block 325. In some embodiments, the method 311 may include emitting photons to provide a binary indication responsive to radiation provided by a source at a first location at block 325.

The method 311 may also include, at block 329, transporting the photons to a second location (e.g., a safety status display, or the exterior of a radiation container), different from the first location, to provide an indication of photon presence at the second location. In some embodiments, the method 311 may include conducting a binary indication (e.g., logic HIGH/LOW, ON/OFF, present/absent) to a second location different from the first location at block 331. The source of radiation, as noted above, may comprise any number of mechanisms, and in some embodiments, may be capable of providing radiation at a rate of greater than about 2·10⁸ particles per second through a surface surrounding the source, such as a substantially spherical surface.

In some embodiments, the method 311 may include receiving the indication at block 333, as well as activating an alarm responsive to an absence of the indication at block 337. The indication may manifest itself in a number of ways, as described previously, including as a visual indication, and/or a binary indication (e.g., observable/non-observable, on/off, radiation source present/not present, etc.). Thus, the binary indication may include a source present state and a source not present state, and the method 311 may include activating an alarm responsive to the source not present state at block 337. As another example, the binary state may include one of an electrical ON state and an electrical OFF state, and the method 311 may include activating an alarm responsive to the electrical OFF state at block 337.

Turning now to FIG. 3B, it can be seen that in some embodiments, a method 351 may (optionally) begin with inserting a source of radiation into the interior portion of a radiation container at block 363. The method 351 may also include carrying the source of radiation in the interior portion of the radiation container at block 363, as noted previously.

The method 351 may include generating a current at a semiconductor junction by receiving radiation at the semiconductor junction at block 363, wherein the radiation is provided by a source at a first location (e.g., the interior of a radiation container, etc.). The method 351 may also include transporting the current to a second location (e.g., the exterior of a radiation container, etc.) different from the first location to provide an indication of source presence at the second location at block 371. As noted previously, the semiconductor junction may comprise a number of structures, including a bipolar junction, a CMOS junction, and a PIN diode junction.

In some embodiments, the method 351 may include converting the indication to a binary indication, perhaps including one of an electrical ON state and an electrical OFF state, at block 375. The method 351 may continue with activating an alarm responsive to the state of the indication, such as the electrical OFF state.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program, such as the activities included in the methods outlined above. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment.

Increased simplicity and reduced cost of detecting the presence of radiation may result from implementing the apparatus, systems, and methods disclosed herein. Some embodiments may also be substantially more rugged than currently available solutions, and thus usable in a wide range of industrial situations, including those present in the oil well drilling environment.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a photon emitter to emit photons responsive to radiation; and
an optical conduit to transport the photons.

2. The apparatus of claim 1, wherein the photon emitter comprises a doped portion of the optical conduit.

3. The apparatus of claim 2, wherein the photon emitter comprises at least one of a scintillator, a crystal, sodium-iodine, a semiconductor junction, a light-emitting transistor, and scintillation plastic.

4. The apparatus of claim 1, further comprising:
a receptor to receive the photons from the optical conduit and to provide an electrical indication of photon presence.

5. The apparatus of claim 4, further comprising:
a threshold indicator to receive the electrical indication of the photon presence and to indicate the photon presence when a number of photons received per unit time is greater than a selected level.

6. The apparatus of claim 5, wherein the threshold indicator further includes an amplifier.

7. The apparatus of claim 5, wherein the threshold indicator further includes a Schmitt trigger.

8. The apparatus of claim 4, further comprising:
a capacitor coupled to the receptor; and
a resistor coupled to the capacitor.

9. The apparatus of claim 8, wherein a time constant associated with the resistor and the capacitor is less than a desired indication response time.

10. The apparatus of claim 8, wherein a time constant associated with the resistor and the capacitor is greater than a reciprocal of a selected number of radiation particles received per second at the photon emitter.

11. The apparatus of claim 4, wherein the receptor comprises one of a photodiode and a photomultiplier.

12. The apparatus of claim 1, wherein the photon emitter is unpowered.

13. The apparatus of claim 1, wherein the photon emitter receives power from a separate power source.

14. An apparatus, comprising:
a photon emitter to emit photons responsive to radiation;
a receptor optically coupled to the photon emitter to provide an electrical indication of photon presence responsive to receiving the photons; and
an electrical conduit to transport the electrical indication of photon presence.

15. The apparatus of claim 14, wherein the electrical conduit comprises a single electrical conductor.

16. The apparatus of claim 14, wherein the photon emitter comprises one of a scintillator, a crystal, sodium-iodine, a semiconductor junction, a light-emitting transistor, and scintillation plastic.

17. The apparatus of claim 14, further comprising:
a threshold indicator to receive the electrical indication of photon presence from the electrical conduit and to indicate the photon presence when a number of photons received per unit time is greater than a selected level.

18. The apparatus of claim 17, wherein the threshold indicator further includes an amplifier.

19. The apparatus of claim 17, wherein the threshold indicator further includes a Schmitt trigger.

20. The apparatus of claim 14, further comprising:
a capacitor coupled to the electrical conduit; and
a resistor coupled to the capacitor.

21. The apparatus of claim 20, wherein a time constant associated with the resistor and the capacitor is less than a desired indication response time.

22. The apparatus of claim 20, wherein a time constant associated with the resistor and the capacitor is greater than a reciprocal of a selected number of radiation particles received per second at the photon emitter.

23. The apparatus of claim 14, wherein the receptor comprises one of a photodiode and a photomultiplier.

24. A system, comprising:
a photon emitter to emit photons responsive to radiation;
an optical conduit to transport the photons; and
a radiation container having an interior portion containing the photon emitter.

25. The system of claim 24, wherein the optical conduit is carried by a passage from the interior portion to an exterior portion of the radiation container.

26. The system of claim 25, wherein the passage comprises a tortuous passage.

27. The system of claim 24, wherein the radiation container comprises a well logging radioactive source pig.

28. The system of claim 24, wherein the radiation container comprises a container to transport radioactive waste.

29. The system of claim 24, wherein the photon emitter is unpowered.

30. The system of claim 24, wherein the photon emitter receives power from a separate power source.

31. A system, comprising:
a photon emitter to emit photons responsive to radiation;
a receptor optically coupled to the photon emitter to provide an electrical indication of photon presence responsive to receiving the photons; and
a radiation container having an interior portion containing the photon emitter and the receptor.

32. The system of claim 31, further comprising:
an electrical conduit to transport the electrical indication of photon presence from the interior portion to an exterior portion of the radiation container.

33. The system of claim 32, wherein the electrical conduit is carried in a tortuous passage.

34. The system of claim 31, wherein the radiation container comprises a well logging radioactive source pig.

35. The system of claim 31, wherein the radiation container comprises container to transport radioactive waste.

36. A system, comprising:
a photon emitter to emit photons responsive to radiation;
an optical conduit to transport the photons; and
a laser to provide the radiation.

37. The system of claim 36, wherein the laser is included in a tool comprising one of a cutting tool and a fusing tool.

38. The system of claim 37, wherein the tool comprises a metal cutting tool.

39. The system of claim 37, wherein the tool comprises a tool to operate on human-tissue.

40. The system of claim 39, wherein the tool to operate on human-tissue provides the radiation in conjunction with a laser-energized water spray.

41. A method, comprising:
emitting photons responsive to radiation at a first location; and
transporting the photons to a second location different from the first location to provide an indication of photon presence at the second location.

42. The method of claim 41, wherein the first location comprises an interior of a radiation container, further comprising:
carrying a source of the radiation in the interior.

43. The method of claim 42, wherein the source of the radiation is capable of providing the radiation at a rate of greater than about 2·10⁸ particles per second through a surface surrounding the source.

44. The method of claim 41, further comprising:
receiving the indication; and
activating an alarm responsive to an absence of the indication.

45. The method of claim 41, wherein the indication comprises a visual indication.

46. The method of claim 41, wherein the indication comprises a binary indication.

47. A method, including:
emitting photons to provide a binary indication responsive to radiation provided by a source at a first location; and
conducting the binary indication to a second location different from the first location.

48. The method of claim 47, wherein the first location comprises an interior of a radiation container, and wherein the second location comprises an exterior of the radiation container.

49. The method of claim 47, wherein the source of the radiation is capable of providing the radiation at a rate of greater than about 2·10⁸ particles per second through a surface surrounding the source.

50. The method of claim 47, wherein the binary indication includes one of a source present state and a source not present state, further comprising:
activating an alarm responsive to the source not present state.

51. The method of claim 47, wherein the binary state includes one of an electrical ON state and an electrical OFF state.

52. The method of claim 51, further comprising:
activating an alarm responsive to the electrical OFF state.

53. An apparatus, comprising:
a semiconductor junction to generate a current responsive to radiation provided by a source; and
a receptor to provide an indication of source presence responsive to the current.

54. The apparatus of claim 53, wherein the semiconductor junction comprises one of a bipolar junction, a complementary metal-oxide semiconductor (CMOS) junction, and a PIN diode junction.

55. The apparatus of claim 53, further comprising:
a threshold indicator to receive the indication of source presence and to indicate the source presence when a current received per unit time is greater than a selected level.

56. The apparatus of claim 55, wherein the threshold indicator further includes an amplifier.

57. The apparatus of claim 55, wherein the threshold indicator further includes a Schmitt trigger.

58. The apparatus of claim 53, further comprising:
a capacitor coupled to the receptor; and
a resistor coupled to the capacitor.

59. The apparatus of claim 58, wherein a time constant associated with the resistor and the capacitor is less than a desired indication response time.

60. The apparatus of claim 58, wherein a time constant associated with the resistor and the capacitor is greater than a reciprocal of a selected number of radiation particles received per second at the semiconductor junction.

61. The apparatus of claim 53, wherein the semiconductor junction is unpowered.

62. A method, including:
generating a current at a semiconductor junction by receiving radiation at the semiconductor junction, wherein the radiation is provided by a source at a first location; and
transporting the current to a second location different from the first location to provide an indication of source presence at the second location.

63. The method of claim 62, wherein the first location comprises an interior of a radiation container, and wherein the second location comprises an exterior of the radiation container.

64. The method of claim 62, wherein the source is capable of providing the radiation at a rate of greater than about 2·10⁸ particles per second through a surface surrounding the source.

65. The method of claim 62, wherein the semiconductor junction comprises one of a bipolar junction, a complementary metal-oxide semiconductor (CMOS) junction, and a PIN diode junction.

66. The method of claim 62, further comprising:
converting the indication to a binary indication including one of an electrical ON state and an electrical OFF state.

67. The method of claim 66, further comprising:
activating an alarm responsive to the electrical OFF state.
